(19) United States
(12) Patent Application Publication
(10) Pub. No.: US 2021/0229972 A1
(43) Pub. Date: Jul. 29, 2021

(54) SPRING DEVICE AND VALVE ASSEMBLY FOR A BEVERAGE CONTAINER

(71) Applicant: Emanuela COVI, Merano (IT)

(72) Inventor: Emanuela COVI, Merano (IT)

(21) Appl. No.: 17/051,032

(22) PCT Filed: Apr. 29, 2019
(86) PCT No.: PCT/IT2019/050084

§ 371 Date: Oct. 27, 2020

(30) Foreign Application Priority Data
Apr. 27, 2018 (IT) 102018000004912

(51) Int. Cl. B67D 1/08

(52) U.S. Cl. CPC B67D 1/0832; B67D 2001/0822; B67D 1/0835

(57) ABSTRACT

A spring device comprises at least one distribution ring and at least two elastic elements configured like a zig-zag spring connected to the at least one distribution ring. The zig-zag spring elements are disposed equidistant around a longitudinal axis of the spring device and extend along respective axes parallel to its longitudinal axis.

### FIELD OF THE INVENTION

The present invention concerns a spring device, of the type that can be used, for example, in a valve assembly which can be installed in beverage containers, advantageously of the disposable type, with two coaxial components, of which an external container, or keg, having the function of support and protection, and an internal container, or bag, used to contain the beverage.

The present invention preferentially, though not exclusively, concerns a spring device and a valve assembly which can be associated with beverage dispensing devices, which allow to remove the beverage by introducing gaseous fluid between the two coaxial containers.

### BACKGROUND OF THE INVENTION

In the state of the art, valve assemblies for controlling and regulating a flow of fluid are known. Their use is widespread in various sectors and in numerous applications where it is necessary to selectively allow and prevent the passage of the fluid under certain conditions of use.

Containers for fluids, in particular for beverages, are also known, comprising valve assemblies and closing devices that allow the beverage to exit during a dispensing step and allow to hermetically seal the container when the dispensing of the beverage is not required.

These valve assemblies generally comprise a shutter which is kept pressed by a helicoidal spring against an aperture for the passage of the fluid, in order to close the aperture. When it is necessary to allow the passage of the fluid, the shutter is moved away from the aperture.

One problem with the valve assemblies associated with containers of the type in question, that is, suitable to attach to and temporarily cooperate with the dispensers, is the closure and seal that they achieve.

A further disadvantage of the known solutions is the considerable cost of disposing of the used containers, complete with their valve assemblies.

For the disposal, in the current state of the art, it is necessary to dismember the various components, as at least one component of the valve assembly, the spring device, is generally made of metal.

This means that the spring device must be recycled separately, which entails costs for disassembling the container, recovering the spring device, different ways of disposal with problems of different storage and different transport and considerable costs.

Furthermore, a metal spring can release substances into the beverage, in transit, that are not suitable for all users, or that users are intolerant to.

A further problem is connected to the fact that the spring devices currently used are generally made with helicoidal springs.

A spring device with helicoidal springs, due to its constitution, regardless of the material it is made of, in any case does not exert a uniform pressure on the entire thrust circumference, but exerts a pressure, even very different, along said circumference.

This means that, in order to obtain the required seal, the spring device must have a redundant thrust capacity, with increased costs, to absorb the differences in circumferential pressure and must cooperate with at least one distribution ring. This is because, in the circumferential zone where the thrust is not fully exerted, the useful and necessary thrust for the desired seal must in any case be guaranteed, even after a period of 90-100 days, including the times required for storing, selling and tapping of the entire beverage present in the internal container.

Document GB-A-2481465 describes a spring device comprising a plurality of sections interconnected one to the other, which are disposed in two stacked rows which are connected in correspondence with alternate joints between adjacent sections.

One purpose of the present invention is to provide a spring device and a connected valve assembly which overcome at least some of the disadvantages of the state of the art.

Another purpose is to provide a spring device which guarantees a uniform thrust pressure along its circumference.

Another purpose is to provide a spring device which maintains its elastic thrust force for a long time, guaranteeing the seal of the valve assembly for the entire duration of the life cycle of the container, that is, from the moment it is filled with the beverage and closed, up to the complete tapping of the beverage, or at least for the entire period of time within the expiry date of the beverage itself, generally for some months.

A further purpose is to provide a spring device and a connected valve assembly which can be recycled and disposed of together with the container itself without the need to disassemble the various components.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

To overcome the problems described above, the applicant has devised, tested and embodied a spring device totally made of plastic, suitable to exert a uniform pressure along the seal circumference.

The spring device can be advantageously used in a valve assembly for keg type containers provided with an external drum and an internal bag, because it is suitable to exert the pressure for a period of time that is more than sufficient in relation to the shelf life of such a container and the beverage contained therein.

The spring device according to the invention is valid in itself or in combination or association with a component of the valve assembly.

According to the invention, the spring device is made of plastic material compatible with the recycling of the plastic containers with two coaxial components, or kegs, so that it is not necessary to perform any disassembly before sending them for disposal.

Furthermore, the plastic used is inert with respect to the beverages and the users of the beverages.

According to the invention, the spring device advantageously comprises at least one distribution ring and at least two elastic elements configured as a linear zig-zag spring connected to the distribution ring, which constitute the spring itself.

According to some embodiments, the at least two zig-zag spring elements are disposed equally distanced around a longitudinal axis of the spring device passing through the center of the distribution ring and extend along respective axes parallel to each other and parallel to the longitudinal axis.

According to an improved variant, the spring device comprises two distribution rings each located in correspondence with one end of the spring device and connecting circumferentially with the same zig-zag springs.

According to a further variant, the distribution rings lie on planes substantially parallel to each other, orthogonal to the longitudinal axis.

According to one variant, there are two zig-zag springs.

According to variant embodiments, depending on the sizes and conformation of the spring device, up to eight zig-zag springs can be provided, all substantially parallel to each other and located axially to the spring device and parallel to its longitudinal axis.

According to a further variant, there are four zig-zag springs which constitute the spring device.

In another variant there are six linear springs.

According to variant embodiments, at various heights, depending on the length of the spring device, circumferential bridges are provided to connect two or more zig-zag springs in order to improve the seal and the functioning.

According to a further variant the linear springs are obtained singly and then connected to each other to form the spring of the spring device.

According to a further variant the linear springs are obtained directly connected to each other in pairs of two.

According to another variant, all the zig-zag springs are connected to each other. According to this variant, it can be provided that each zig-zag spring has common connection points with the zig-zag springs disposed adjacent thereto along the circumference.

According to one variant, the linear springs are made singly and are subsequently associated with the distribution rings and the components are made reciprocally stable.

According to a further variant, the zig-zag springs and the distribution rings are obtained in a single body forming the spring device.

According to some embodiments, the zig-zag springs can have different geometries, so that it is possible to have undulations, linear zig-zag shapes, arched zig-zag shapes, successive waves with positive and/or negative developments, or a combination thereof.

According to some embodiments, the zig-zag springs have a profile with a plurality of crests and troughs which define respective concavities positioned alternately one after the other.

According to some embodiments, the crests and troughs extend on opposite sides with respect to the longitudinal center line of the zig-zag springs.

According to some embodiments, the transition zones between crests and troughs are located in correspondence with the longitudinal center line of the respective zig-zag springs.

According to a further variant, the crests and troughs are defined by portions with a substantially circular shape located one after the other so that the respective convexities and concavities are opposite each other.

According to a further variant, the crests and troughs are defined by substantially linear segments located reciprocally in a zig-zag pattern at a defined angle.

According to a further variant, the crests and troughs are defined by curvilinear portions, for example extending reciprocally in a zig-zag pattern, that is, in directions alternating on each occasion.

Embodiments described here also concern a valve assembly comprising a valve body and a spring device according to the present invention.

Further embodiments also concern a beverage container comprising a valve assembly according to the invention.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a three-dimensional view of a spring device according to embodiments described here;

FIG. 2 is a section view along the plane II-II of FIG. 1;

FIG. 3 is a section view of a valve assembly according to embodiments described here;

FIG. 4 is a section view of a variant of a spring device according to embodiments described here;

FIG. 5 is a section view of another variant of a spring device according to embodiments described here.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

We will now refer in detail to the various embodiments of the present invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

Embodiments described here with reference to the attached drawings concern a spring device 10.

The spring device 10 can advantageously, though not exclusively, be used in a valve assembly 24 of the type that can be associated with beverage containers, or kegs, not shown, comprising an external container, or drum, and an internal container, or bag.

According to some embodiments, the material which the spring device 10 consists of is advantageously PET, or any other plastic material compatible for recycling.

In this way, the spring device 10, if applied to a valve assembly 24 for a beverage container, can be disposed of and recycled together with the other components of the finished container.

According to some embodiments, the spring device 10 comprises at least one distribution ring 11a, 11b and at least two elastic elements 12 configured as a zig-zag spring connected to the distribution ring 11a, 11b, which constitute the spring itself, that is, the elastic element.

According to some embodiments, the at least two elastic elements 12 configured as a zig-zag spring are independent from one another, that is, they are not connected to each other.

According to some embodiments, the at least two elastic elements configured as a zig-zag spring 12 are disposed equally distanced around a longitudinal axis X of the spring device 10 passing through the center of the distribution ring 11a, 11 b and extend along respective axes parallel to each other and parallel to the longitudinal axis X.

In this way, the compression force exerted on the lower distribution ring 11a will be substantially uniform along its entire circumference.

According to some embodiments, the spring device 10 comprises two distribution rings 11a and 11b, of which a lower distribution ring 11a and an upper distribution ring 11b. According to some embodiments, the zig-zag spring elements 12 are connected to both the distribution rings 11a, 11b in correspondence with their ends.

According to some embodiments, the zones where the zig-zag springs 12 and the distribution rings 11a 11b connect are substantially aligned with each other along the respective circumferences of the lower 11b and upper 11a distribution rings. That is to say, the connection zones on the two distribution rings 11a, 11b are substantially aligned along respective vertical axes parallel to the horizontal axis.

According to some embodiments, the distribution rings 11a and 11b lie on respective planes parallel to each other and orthogonal to the longitudinal axis X.

Thanks to the conformation with distribution rings 11a, 11b and zig-zag springs 12 disposed between them, the spring device 10 according to the invention is advantageously such as to be able to still exert, at the end of its life-cycle, in operation, at least 120-130 N and to be able to yield from 8 mm up to 18-20 mm.

The spring device 10 can therefore perform the function of a shutter for a valve assembly 24 connectable to dispensing devices (not shown), in any case guaranteeing on the one hand the correct and complete dispensing of the beverage contained in the container during the dispensing operations and, on the other hand, the correct hermetic seal of the valve assembly in the event of removal of the dispensing devices.

The spring device 10 is in particular sized so as to maintain a thrust approximate to a minimum value permitted during the maximum time expected to be necessary for storage, transport, storage in the user's warehouse and tapping.

According to some embodiments, the zig-zag springs 12 can be conformed with different geometries, so that it is possible to have undulations, linear zig-zag shapes, arched zig-zag shapes, consecutive waves with positive and/or negative developments, or a combination thereof.

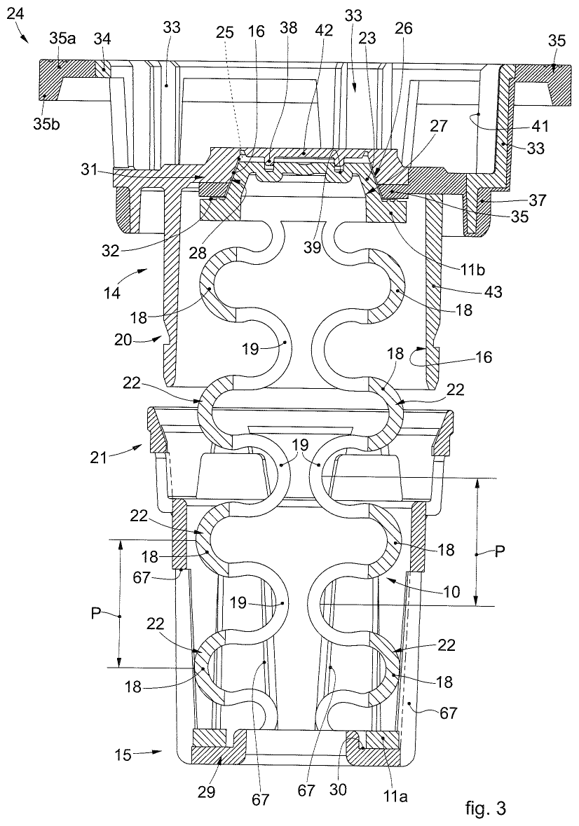

According to possible solutions, for example shown in FIG. 3, the spring device 10 has a circular section, that is, it comes within a cylinder with a diameter between 25 and 35 mm, advantageously around 30 mm, but it can also have other compatible sizes according to the application of the spring device 10.

According to some embodiments, the zig-zag springs 12 that define the spring device 10 are advantageously conformed so as to remain inside a cylindrical ring, the sizes of which are defined by the lower 11a and upper 11b distribution rings.

According to these embodiments, the spring device 10 comprises an internal compartment 13 substantially cylindrical in shape through which, during use, the beverage to be dispensed can pass.

According to some embodiments, the zig-zag springs 12 can have a constant thickness along their longitudinal development.

By way of example, the thickness of the individual zig-zag springs 12 can be about 1.5 mm, but can vary from 1 to 2.5 mm.

According to some embodiments, the zig-zag springs 12 have a profile with a plurality of crests 18 and troughs 19, defining respective alternating convexities and concavities, located in succession one after the other.

According to some embodiments, the crests 18 and the troughs 19 extend on the two sides with respect to a longitudinal center line M of the zig-zag springs 12.

According to some embodiments, the transition zones between crests 18 and the troughs 19 are disposed in correspondence with the longitudinal center line M of the respective zig-zag springs 12.

According to some embodiments, the pitch P between the crests 18 and, respectively, between the troughs 19, can be comprised between about 15 mm and about 20 mm.

According to some embodiments described with reference to FIG. 2, the zig-zag springs 12 have a wave-shaped conformation defined by consecutive circumferences, that is, the crests 18 and the troughs 19 are defined by substantially circular-shaped portions located in succession one after the other.

By way of example, the diameter of the waves that define the crests 18 and the troughs 19 can be comprised between 5 mm and 7 mm, advantageously around 6 mm.

In the example given, there are four waves that define the crests 18 and there are three waves that define the troughs 19, plus two half-waves which are anchored in a single body with the respective distribution rings 11a and 11b.

According to a further variant, instead of the circle portions, it is possible to obtain waves consisting of substantially identical curved profiles that follow each other inverted.

According to one variant, instead of using curved profiles, substantially identical, profiles with different lengths and/or widths can also be used.

The shape of the zig-zag springs 12, according to one variant shown by way of example in FIG. 5, is obtained with arched segments that follow each other continuously.

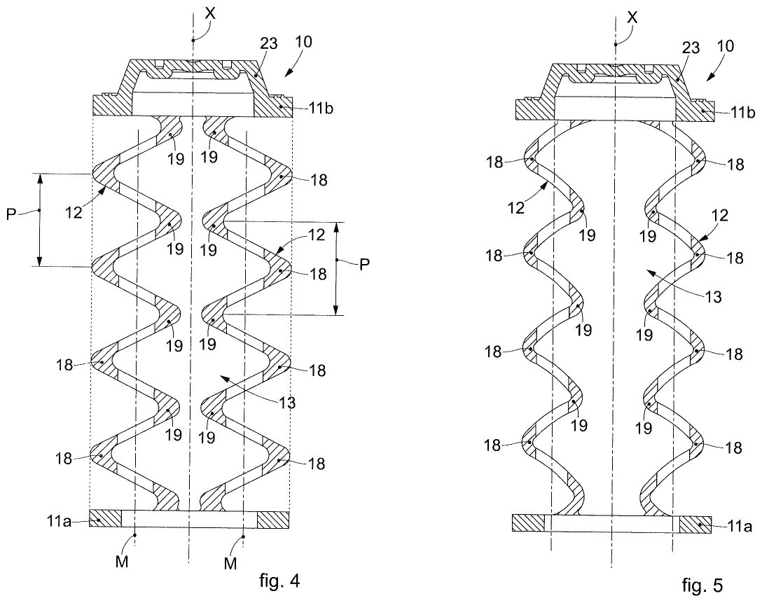

According to one variant, shown by way of example in FIG. 4, the zig-zag springs 12 are conformed with linear segments inclined in opposite directions, connecting to each other at their respective ends.

According to one variant, a possible reinforcement is provided at the point of connection between the arched segments and/or between the inclined segments.

According to possible embodiments, the spring device 10 has two zig-zag springs 12. According to these embodiments, the zig-zag springs 12 can be disposed at 180° with respect to each other with respect to the longitudinal axis X, with respective opposite crests 18 and troughs 19.

It goes without saying that there can also be three or more single zig-zag springs 12, for example six, and they can be obtained in a single body and then integrated with said distribution rings 11a and 11b, forming the spring device 10.

According to variant embodiments, depending on the sizes and the conformation of the spring device 10, up to eight zig-zag springs 12 can be provided, extending along respective axes substantially parallel to each other and disposed in an axial direction to the spring device 10 and parallel to its longitudinal axis X.

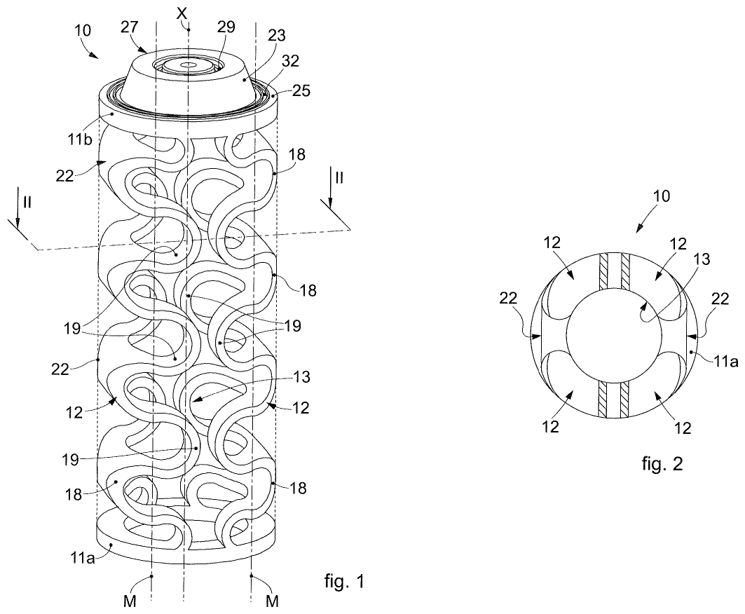

According to embodiments described for example with reference to FIGS. 1-4, there are four zig-zag springs 12 which make up the spring device 10, two opposite pairs.

According to further embodiments, the four zig-zag springs 12 are disposed symmetrically with respect to a longitudinal plane passing through the longitudinal axis X.

According to some embodiments, the four zig-zag springs 12 are connected in pairs in correspondence with the respective adjacent crests 18 by means of external connection bridges 22 which also act as a single external wave.

According to some embodiments, the zig-zag springs 12 have a substantially constant width along their longitudinal development.

According to variant embodiments, the zig-zag springs 12 have a variable width along their longitudinal development, for example in the zones affected by the external connection bridges 22.

According to some embodiments, the spring device 10 comprises an upper portion 23 suitable to act as a shutter element for a valve assembly 24.

According to some embodiments, the upper portion 23 has a truncated cone shape.

According to some embodiments, the valve assembly 24 comprises a passage aperture 25 for the beverage to be tapped (indicated with dashed lines in FIG. 3) and a mobile sealing unit 26 which, during use, is configured to selectively close and open the passage aperture 25.

According to some embodiments, the mobile sealing unit 26 can comprise a male component 27 and a female component 28 at least partially mating in shape, which can be coupled to each other in order to close the passage aperture 25.

According to some embodiments, the upper portion 23 of the spring device 10 can be made as the male component 27, and the female component 28 can be provided in a valve body 14 of the valve assembly 24.

According to some embodiments, the spring device 10 can be made by molding providing, for example, that the mold has a male cylindrical body, not shown, which conforms the internal compartment 13 of the spring device 10 and the upper portion 23, if integral with said spring device 10.

According to some embodiments, the upper distribution ring 11b, in the surface facing, during use, toward the outside, has at least one rib 32 which develops circumferentially.

According to some embodiments, two or more circumferential ribs 32 can be provided, possibly concentric to each other.

According to some embodiments, the ribs 32 can cooperate with a sealing element 35 provided on a valve assembly 24 to guarantee the hermetic seal of the latter, as will be described below.

Embodiments described here also concern a valve assembly 24 which, with the aid of a closing device (not shown) is associated with a container, or keg.

The valve assembly 24 comprises a valve body 14, a support element 15 and a spring device 10 enclosed between the valve body 14 and the support element 15.

According to some embodiments, the valve body 14 and the support element 15 each comprise a cavity 16, 17 suitable to house at least part of the spring device 10.

According to some embodiments, the valve body 14 and the support element 15 are provided with respective mating coupling members 20, 21, suitable to define a stable coupling of the two components, and to maintain the spring device 10 located between them compressed.

According to some embodiments, the coupling members 20, 21 can be chosen from same-shape, snap-in, bayonet coupling members or suchlike, so that the use of specific tools is not necessary.

According to some embodiments, the coupling members 20, 21 are located in correspondence with the respective edges of the valve body 14 and of the support element 15 delimiting the respective cavities 16, 17.

According to some embodiments, it can be provided that the coupling members 20, 21 are respectively disposed in correspondence with an external surface of the valve body 14 and in correspondence with an internal surface of the support element 15, providing that the valve body 14 is inserted partially into the cavity 17 of the latter.

According to a possible variant, not shown, the coupling members 20, 21 can be provided in correspondence with the internal wall of the valve body 14 and the external wall of the support element 15, so that the latter is partially inserted into the cavity 16 of the valve body 14.

According to some embodiments, the coupling members 20, 21 comprise a female annular recess 20 and a male annular attachment 21.

The spring device 10, in the example given in FIG. 3, during use, rests on a base 29 of the support element 15, removable, which is anchored to the valve body 14 by means of the respective coupling members 20, 21.

According to one variant, instead of the support, the support element 15 can have a seating 30 with an internal circumferential attachment groove, in which the lower distribution ring 11a anchors peripherally, for example, in an elastic manner.

According to further variant embodiments, fissures or slits 44 can be made in the lateral wall of the support element 15, configured to make the internal surface of the support element 15 accessible and allow it to be cleaned and sanitized, for example by UV rays, infrared rays, washing fluids, or other.

According to embodiments described with reference to FIG. 3, the valve body 14 comprises a base body of rigid plastic material and a plurality of gaskets 35, 36, 37 made of a soft and flexible plastic material integrally associated with each other.

With reference to FIG. 3, the valve body 14 comprises an upper annular portion 34, an intermediate equipped wall 31, or plate, and a lower extension 40.

In the equipped wall 31 there is a sealing lid 42 and the female component 28.

The sealing lid 42 is defined by a central portion of the equipped wall 31 with a smaller thickness, which is configured to be separated from the equipped wall 31 when a dispensing device is first inserted.

According to some embodiments, the sealing lid 42 has at the lower part an annular protrusion 38 suitable to be inserted in the annular recess 39 made on the male component 27, that is, on the upper portion 23 of the spring device 10.

In this way, when the dispensing device presses the sealing lid 42 and separates it from the equipped wall 31, it anchors itself to the spring device 10, becoming part of the male component 27.

When the dispensing device is removed, the elastic compression force of the spring device 10 will tend to extend the latter, taking the male component 27 and therefore the sealing lid 42 connected thereto to couple with the female component 38 and the equipped wall 31 so as to close the passage aperture 25.

The upper annular portion 34 is connected to the equipped wall 31 by means of connection elements 33.

According to some embodiments, the connection elements 33 alternate with transit slits 41, between the upper annular portion 34 and the intermediate equipped wall 31.

According to some embodiments, the connection elements 33 are equally distanced along the circumference of the upper annular portion 34 and of the equipped wall 31.

The connection elements 33 can have ribs or ridges necessary for the connection to the dispensing device.

According to some embodiments, the valve body 14 further comprises an annular abutment wall 43, external and coaxial to the lower extension 40, suitable to cooperate, during use, with the internal component of the two-component container.

According to some embodiments, the gaskets 35, 36, 37 comprise one or more of either an upper gasket 35 associated with the upper annular portion 34, an internal gasket 36 associated with the equipped wall 31, and a lateral gasket 37 associated with the annular support 20.

According to possible solutions, the upper gasket 35 has an L-shaped section, with a first segment 35a which develops in a radial direction from the upper annular portion 34, and a second segment 35b which develops transversely to the first segment 35a facing toward the equipped wall 31.

According to possible solutions, the lateral gasket 37 is associated with the abutment wall 43 and extends over the entire external circumference of the latter so that, during use, it is in contact on each point with an internal surface of the internal container.

According to some embodiments, the lower gasket 52 has an annular shape and is associated with the equipped wall 31 around the passage aperture 25 defined by the female component 28.

According to some embodiments, in the case shown, the upper distribution ring 11b cooperates with the male element 27, or upper portion 23 of the spring device 10. Furthermore, in its circumferential extension the upper distribution ring 11b also acts as a flat valve cooperating with the internal gasket 36 associated with an equipped wall 31, in the case shown, of the valve body 14.

The circumferential ribs 32 on the upper distribution ring 11b, if provided, can promote and stabilize the seal between the upper distribution ring 11b and the internal gasket 36.

Even if the example shows the male element 27 integral with the spring device 10, in practice, as a variant of said spring device 10, the female component 28 could be integral, and the male element 27 of the mobile seal assembly 26 attached to the valve body 14.

It is in the spirit of the invention that the male component 27, or possibly the female component 28, and the spring device 10 are made as two separate elements obtained separately and then assembled.

According to some embodiments, the sizes of the lower extension 40 (internal diameter and length) are correlated to the requirements of the spring device 10.

In the case shown in FIG. 3, the lower extension 40 has an external diameter smaller than the internal diameter of the annular abutment wall 43, which supports the lateral gasket 37 which cooperates with the neck of the internal container (not shown).

If the requirements of the spring device 10 required it, the external size of the lower extension 40 of the valve body 14 could also be approximate, or identical, to the external diameter of the annular abutment wall 43.

It is clear that modifications and/or additions of parts may be made to the spring device 10 and valve assembly 24 as described heretofore, without departing from the field and scope of the present invention.

It is also clear that, although the present invention has been described with reference to some specific examples, a person of skill in the art shall certainly be able to achieve many other equivalent forms of spring device 10 and valve assembly 24, having the characteristics as set forth in the claims and hence all coming within the field of protection defined thereby.

1. Spring device comprising at least one distribution ring and at least two elastic elements configured like a zig-zag spring connected to said at least one distribution ring, said zig-zag spring elements being disposed equidistant around a longitudinal axis (X) of said spring device and extending along respective axes parallel to said longitudinal axis (X).

2. Spring device as in claim 1, being completely made of recyclable plastic material.

3. Spring device as in claim 1, further comprising two load distribution rings, of which one lower distribution ring and one upper distribution ring, each located in correspondence with one end of said spring device and connecting circumferentially with said zig-zag springs.

4. Spring device as in claim 3, wherein said distribution rings lie on planes substantially parallel to each other, and orthogonal to said longitudinal axis (X).

5. Spring device as in claim 3, wherein said zig-zag springs are conformed so as to remain inside a cylindrical ring volume, the sizes of which are defined by said lower and upper distribution rings.

6. Spring device as in claim 1, further comprising four elastic zig-zag spring elements in opposite pairs and connected in pairs with respect to each other in correspondence with an external portion thereof.

7. Spring device as in claim 1, wherein said zig-zag springs have a wave profile with a plurality of crests and troughs, defining respective alternate convexities and concavities, located one after the other, wherein said crests and troughs are defined by circular portions located one after the other.

8. Spring device as in claim 1, wherein said zig-zag springs have a thickness comprised between 1 mm and 2.5 mm.

9. Spring device as in claim 1, wherein the width of the waves of the individual linear zig-zag springs is comprised between 5 mm and 7 mm.

10. Spring device as in claim 1, wherein the linear zig-zag springs and the upper and/or lower distribution rings are obtained singly and then assembled in a stable manner.

11. Spring device as in claim 1, wherein said zig-zag springs and/or said upper and/or lower distribution rings are obtained in a single body.

12. Valve assembly for a beverage container of the keg type provided with an external keg and an internal bag, wherein the valve assembly comprises a valve body, a support element and a spring device as in claim 1, enclosed between said valve body and said support element.

13. Valve assembly as in claim 12, wherein said at least one distribution ring is disposed at a lower end of said spring device and is anchored at least in two points present in an internal periphery of said support element.

14. Valve assembly as in claim 12, wherein said spring device rests on a seating present on said support element.

15. Valve assembly as in claim 12, wherein one load distribution ring (11a or 11b) is associated with, or made in a single body with, a component of a mobile sealing unit (26) of said valve assembly.

16. Container of the keg type for beverages provided with an external keg and an internal bag, wherein the container comprises a valve assembly (24) as in claim 12.
